(19) United States
(12) Patent Application Publication
(10) Pub. No.: US 2013/0173162 A1
(43) Pub. Date: Jul. 4, 2013

(54) FIELD DETECTING DEVICE

(71) Applicant: Chung Yuan Christian University, Taoyuan County (TW)

(72) Inventors: Wen-Yaw Chung, Taoyuan County (TW); Erik S. Jeng, Taoyuan County (TW)

(73) Assignee: CHUNG YUAN CHRISTIAN UNIVERSITY, Taoyuan County (TW)

(21) Appl. No.: 13/722,318

(22) Filed: Dec. 20, 2012

(30) Foreign Application Priority Data
Dec. 30, 2011 (TW) 100225067

(51) Int. Cl. G06F 17/00

(52) U.S. Cl. CPC G06F 17/00
USPC 702/2

(57) ABSTRACT

A field detecting device includes at least one detecting module, a server module and a power module. Each of the detecting module, the server module and the power module has a casing. A first fixing structure and a first connecting pin are provided on the upper surfaces, and a second fixing structure and a connecting second pin are provided on the lower surface. The power module is capable of powering the detecting module and the server module. The server module is capable of driving the at least one detecting module according to the environment detecting program, so as to receive the environment detecting signals. Therefore, the assembling order of the detecting modules, the server module and the power module can be changed.

### CROSS REFERENCE TO RELATED APPLICATIONS

This non-provisional application claims priority under 35 U.S.C. §119(a) on Patent Application No. 100225067 filed in Taiwan, R.O.C. on Dec. 30, 2011, the entire contents of which are hereby incorporated by reference.

### BACKGROUND

1. Technical Field

The disclosure relates to a detecting device, and more particularly to a detecting device for detecting the state of a field.

2. Related Art

In the ordinary planting manner, changes of the planting environment are determined manually. However, the determination heavily depends on the experiences of the cultivators which are accumulated for long time. Since the determinations of the environment change are different in personal cognition, it is difficult to obtain the same judgment from different people and to teach the skill of determination to other people.

Therefore, some manufacturers attempt to monitor the planting environment in the growing period of the plants. However, some detecting devices are merely used for detecting a certain environment variable. Thus, it is difficult to know the entire environment variables. And if all the environment variables need to be detected, a lot of different detecting devices should be provided. Accordingly, excepting for occupying more filed space, it is also not convenient for providing or managing these detecting devices.

### SUMMARY

The disclosure provides a field detecting device includes: at least one detecting module, a server module and a power module. Wherein, the detecting module, the server module and the power module have respective casings respectively. And each of the casings has an upper surface, a lower surface and an outer surface. Wherein, a first fixing structure and first connecting pins are provided on the upper surfaces, and a second fixing structure and connecting second pins are provided on the lower surface. The configuration of the first fixing structure is corresponding to the configuration of the second fixing structure. Here, the first fixing structure and the second fixing structure may be, but not limited to, crew fixing structures, spiral fixing structures, joint structures or magnetic fixing structures.

### BRIEF DESCRIPTION OF THE DRAWINGS

The present disclosure will become more fully understood from the detailed description given herein below for illustration only, and thus are not limitative of the present disclosure, and wherein:

FIG. 1A is a perspective view of a detecting device of the disclosure;

FIG. 1B is a block diagram representing the detecting device of the disclosure;

FIG. 2A is a structural view of the external screw fixing structure used in the disclosure;

FIG. 2B is a spiral fixing structure used in the disclosure;

FIG. 2C is a joint fixing structure used in the disclosure;

FIG. 2D is a screw fixing structure used in the disclosure;

FIG. 2E is a magnetic fixing structure used in the disclosure;

FIG. 2F is a fastener fixing structure used in the disclosure;

FIG. 3 is an assembly drawing of one embodiment in the disclosure; and

FIG. 4 is an assembly drawing of another embodiment in the disclosure.

### DETAILED DESCRIPTION

For the solving the problems mentioned above, the disclosure provides a field detecting device where the assembling order of detecting modules, a server module and a power module can be varied with the environment.

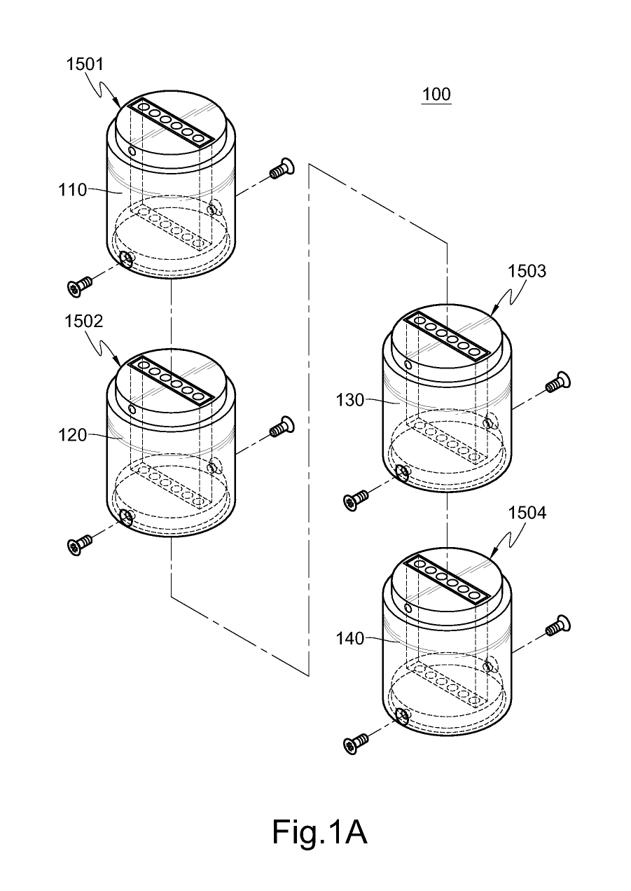

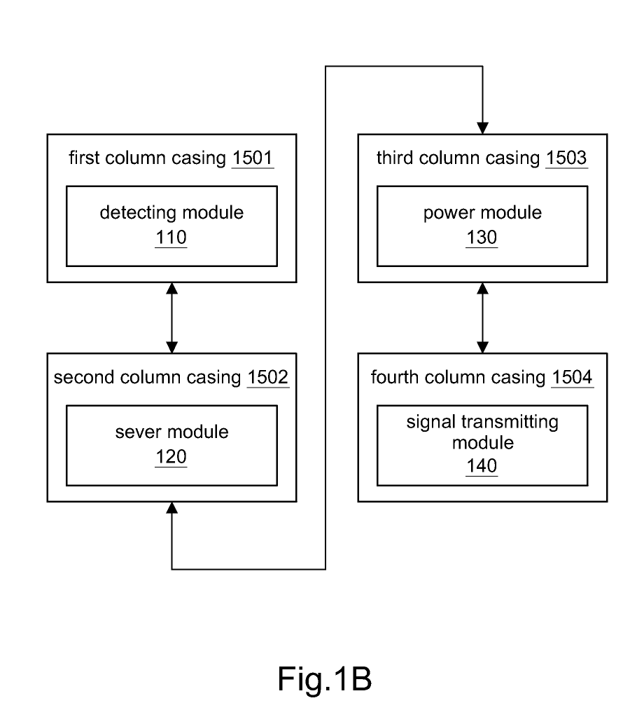

In addition to the planting environment, the detecting device of this disclosure also can be applied in greenhouse. Referring to FIGS. 1A and 1B, FIG. 1A is a perspective view of a detecting device of this disclosure, while FIG. 1B is a block diagram representing the detecting device of this disclosure. The detecting device 100 of the disclosure includes at least one detecting module 110, a sever module 120, a power module 130 and a signal transmitting module 140. Each of the detecting module 110, the server module 120 and the power module 130 has a casing 150 in the shape of column. Here, the shapes of the casings 150 of the detecting module 110, the server module 120 and the power module 130 are not limited to cylinder, the shapes of the also can be a polyhedral. Furthermore, the shapes of the casings may be different from each others.

For distinguishing the different casings 150 provided for the different modules, the casings 150 of the detecting modules 110 is defined as “first casing 1501”, the casing 150 of the server module 120 is defined as “second casing 1502”, the casing 150 of the power module 130 is defined as “third casing 1503”, and the casing 150 of the signal transmitting module 140 is defined as “fourth casing 1504”.

According to the different detecting environments, the detecting module 110 can be arranged in the first casing 1501 or on the outer surface 153 of the first casing 1501. The detecting module 110 has first connecting pins 171 and second connecting pins 172, opposing to each other. The detecting module 110 further comprises electronic elements for detecting environment. Here, the detecting module 110 may be, but not limit to, a video unit, a sound receiving unit, an electronic nose, an electronic tape, a pressure detecting unit, a temperature detecting unit, a humidity detecting unit, a water quality detecting unit or a solid detecting unit. The electronic tape is composed of a group of artificial films formed on a monolithic silicon (Multi-sensor), and each of the artificial film has different sensitivities to different chemicals respectively. Thus, the electronic tape is configured to distinguish the type of the object to be detected. The electrical nose is a gas sensor for emulating the olfactory receptor cell of human beings, and the electrical nose has a high sensitivity for detecting gases such as amines, aldehydes and alcohols. And the environment detecting signals may be environment video signals, environment acoustic signals, environment olfactory signals, environment taste signals, environment pressure signals, temperature signals, humidity signals, water quality detecting signals or solid detecting signals.

Elements of the server module 120 are disposed in the second casing 1502, and are electrically connected between the first connecting pin 171 and the second connecting pin 172. And the sever module 120 further comprises a processing unit (not shown) and a storage unit (not shown). The processing unit is electrically connected to the storage unit, and the storage unit is used to store an environment detecting program. When the server module 120 is connected to other detecting module 110, the type of the detecting module 110 is learned by the connecting pins. Here, the processing unit processes the corresponding environment detecting process, according to the detecting module 110 connected to the processing unit.

The elements of the power module 130 are disposed in the third casing 1503 and are electrically connected between the first connecting pin 171 and the second connecting pin 172. The power module 130 is used to power the detecting modules 110, the sever module 120 and the signal transmitting module 140. Here, the power module 130 may be, but not limited to, a solar cell, a hydrogen-oxygen cell, a lithium cell, a zinc-manganese cell, a carbon-zinc cell or an external power.

Furthermore, the elements of the signal transmitting module 140 are disposed in the fourth casing 1504 and are electrically connected between the first connecting pin 171 and the second connecting pin 172. After the detecting module 110 receives the environment detecting signals, the environment signals are sent by the server module 120 through the signal transmitting module 140. The transmission type of the signal transmitting module 140 may be Ethernet, IEEE 802.11 wireless network, 3rd-generation (3G) mobile communication, WiMax, Ultra-wide band or Universal Serial Bus (USB).

The position of the first connecting pin 171 on the upper surface 151 is corresponding to the position of the second connecting pin 172 on the lower surface 152. In other words, when a first fixing structure 161 is assembled with a second fixing structure 162, the first connecting pin 171 is connected to the second connecting pin 172 through the electronic elements in every module. Therefore, the data transferring (or the power transferring) between the two modules (i.e., the detecting modules 110, the sever module 120, the power module 130 or the signal transmitting module 140) can be implemented by the first connecting pin 171 and the second connecting pin 172. Here, the number of the pins in the first connecting pin 171 (or the second connecting pin 172) is not limited.

Each of the casings 150 has an upper surface 151, a lower surface 152 and an external surface 153. The first fixing structure 161 and the first connecting pin 171 are provided on the upper surface 151, while the second fixing structure 162 and the second connecting pin 172 are provided on the lower surface 152. Here, the configuration of the first fixing structure 161 is corresponding to the configuration of the second fixing structure 162. Both of the first fixing structure 161 and the second fixing structure 162 can be screw fixing structures, spiral fixing structures, joint structures or magnetic fixing structures (the other fixing manners will be described later).

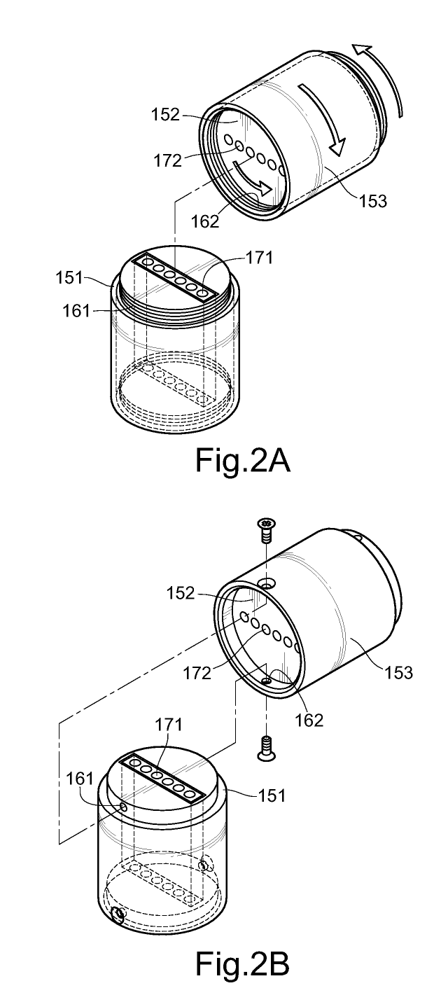

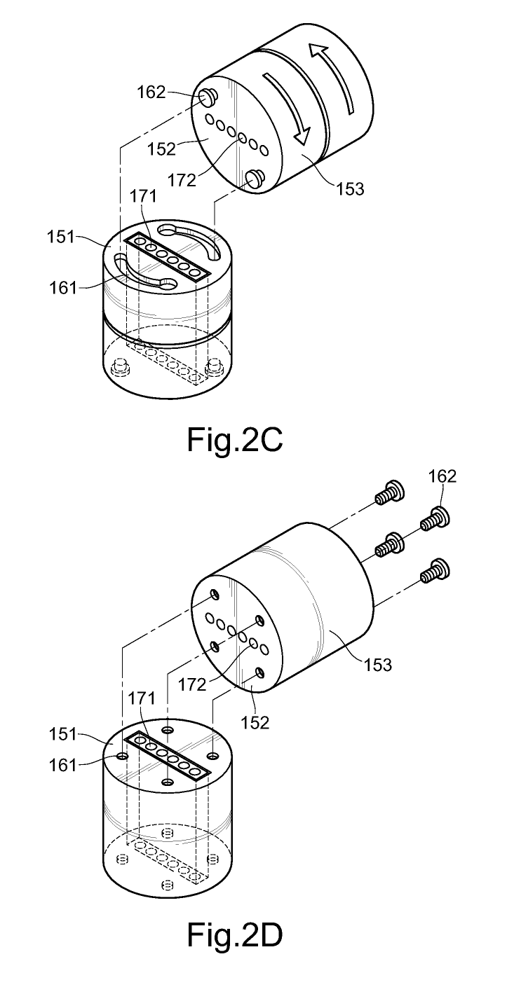

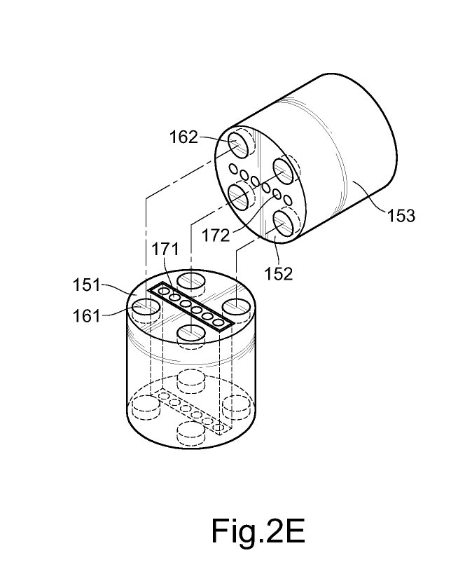

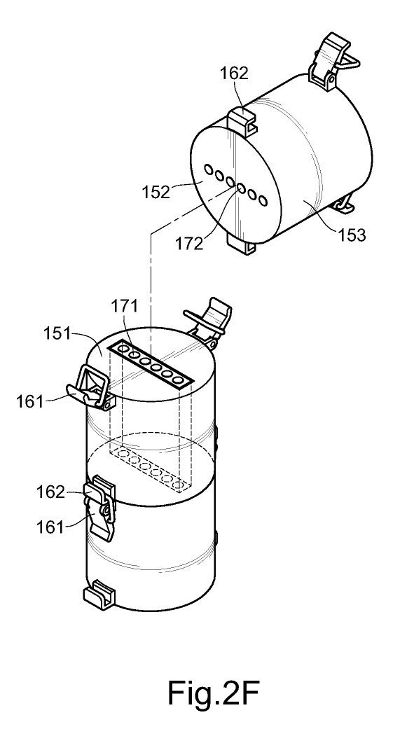

Taking the screw fixing structure as an example, some protruding sides are provided on the edge of the upper surface 151, and the first holes are provided in the each protruding side. Here, the second holes, in an equal number of the first holes, are provided on the external surface 153 beside the lower surface 152 corresponding to the first holes. As shown in FIG. 2A, when the two modules are connected, the first holes overlap the second holes on another module. And then, the screws pass through the first and second holes, so as to fix the relative position of the two modules.

Except for the screws fixing as mentioned above, the protruding side as shown in FIG. 2B can be provided at edge of the upper surface 151 of the casings 150, wherein the threads are provided on the protruding side. For the same reason, the edge of the lower surface 152 is also provided with threads. Therefore, the two modules can be fixed using the screw fixing structure. Here, the first fixing structure 161 of the casing 150 can rotate about the second fixing structure 162. Here, the position of the first connecting pins 171 on the upper surface 151 is corresponding to the position of the second connecting pins 172 on the lower surface 152. Thus, while the two modules are assembled, the first connecting pins 171 are electrically connected to the second connecting pins 172. In another word, the first connecting pins 171 are connected with the second connecting pins 172; and then the first fixing structure 161 of the first casing 1501 is aligned with the second fixing structure 162 of the second casing 1502 and rotates about the second fixing structure; finally, the first fixing structure 161 is coupled with the second fixing structure 162 by the threads provided on the edge.

Except for the thread fixing structure, a plurality of bumps can be provided on the lower surface 152. A plurality of grooves is provided at the positions corresponding to the bumps on the upper surface 151, as shown FIG. 2C. When the two modules are assembled, the plurality of the bumps is embedded into the plurality of the grooves on the other module, for preventing the lateral movement between the two modules. Except for the manners as mentioned above, the first connecting pin 171 and the second connecting pin 172 are provided on the upper/lower surfaces of the casing 150, respectively. As shown in FIG. 2D, the first connecting pin 171 is fixed to the second connecting pin 172 using a plurality of screws.

Furthermore, as shown in FIG. 2E, a plurality of magnets also can be provided on the upper surface 151, in this case a plurality of magnets having inverse magnetic property (or iron plates) are provided on the lower surface 152. When the two modules are assembled, the magnets on the two modules attract to each others, so as to fix the two modules. Except for the fixing structures as mentioned above, the various fixing structures provided on the upper surface 151 and the lower surface 152 can be exchanged each other.

Except for the manner mentioned above, the first fixing structure 161 and the second fixing structure 162 can be provided on the upper/lower edges of the casing 150, respectively. The first fixing structure 161 and the second fixing structure 162 have corresponding fasteners, refer to FIG. 2F. When the first casing 1501 closes to second casing 1502, the first casing 1501 is fixed to the second casing 1502 by clipping.

According to the room temperature of the planting environment, the detecting module 110 can be assembled in different orders. Generally, the temperature, the humidity, the illumination and the carbon dioxide content in the green house need to be monitored. As the air temperature in the green house is increased, all of the photosynthesis, the oxygenation and the metabolism are increased, while the temperature of the leave will be increased, thus the evaporated quantity of the moisture in the leaf is increased. Here, a low humidity of the air will cause the air-intake hole close. Thus, humidity should be maintained in a high level to make the leaves stretch, so that the air-intake holes of the plant can be completely opened. Furthermore, when the temperature of the soil is low, the absorptions of the water and nutrition of the plants may be affected, and, at the same time, the saturation dissolved oxygen of the water culture solution will be decreased as the water temperature is increased.

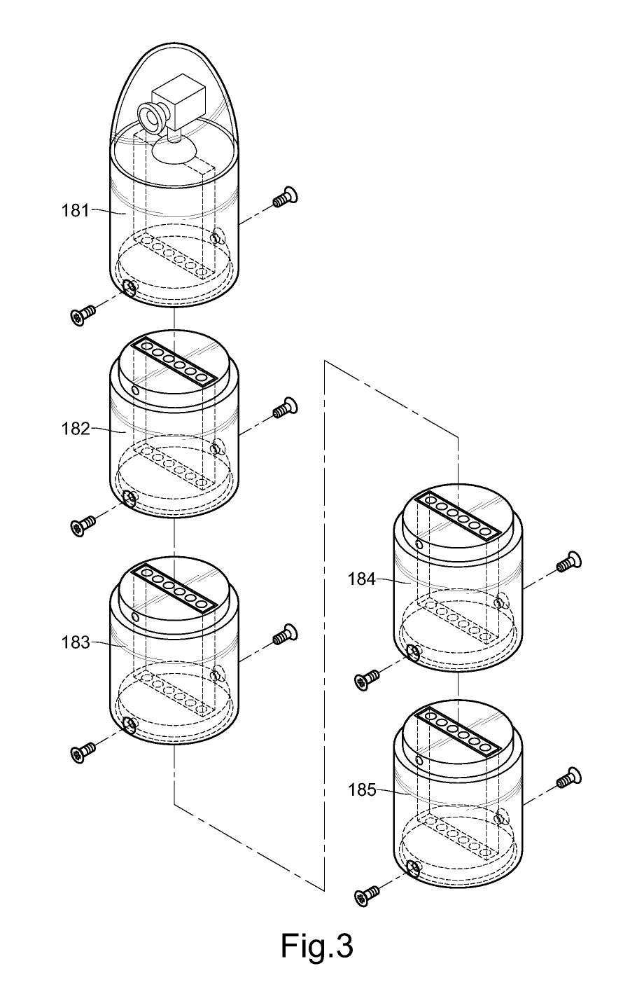

For monitoring each one of the environment information, the illumination can be monitored by a video detecting module 181, and thus the video module 181 can be arranged in the foremost position in the detecting device. FIG. 3 is an assembly drawing of the detecting modules of the disclosure. Here, the video module 181, a temperature detecting module 182, a humidity detecting module 183 and a carbon dioxide content detecting module 184 are assembled sequentially. In this embodiment, because the monitoring is performed in the greenhouse, the detecting device 100 is powered by an external power. At the same time, by the wired network, the related environment information detected may be send to a server. Furthermore, the server module 120 and the power module 130 may be disposed in the lower layers of the detecting device 100.

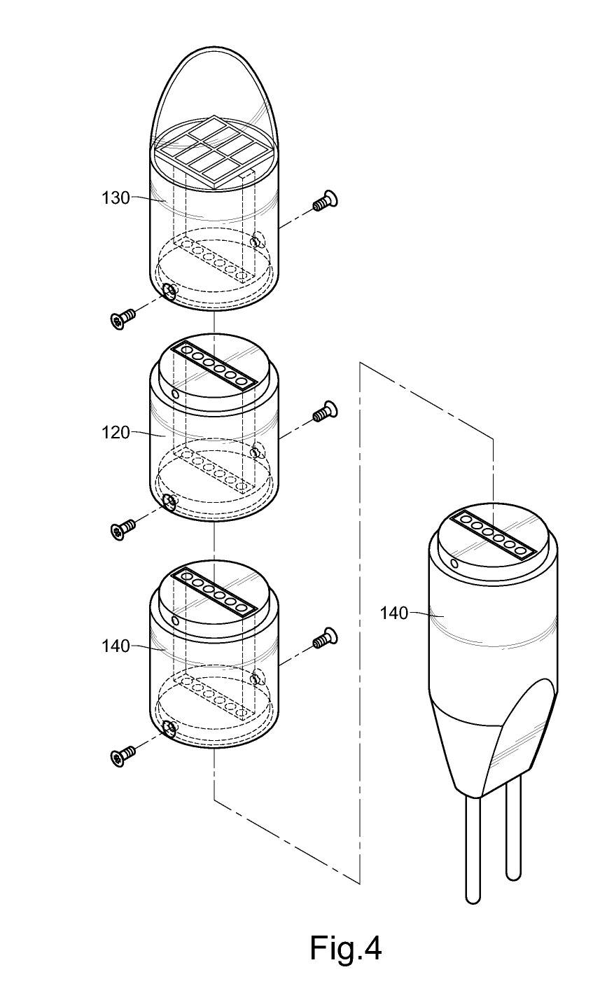

In addition to the embodiments as mentioned above, the assembling order of the detecting modules 110 can be changed, according to the different field planting environment. For example, when the water quality, the solid and the humidity in one rice-growing field need to be detected, the water quality detecting module, the solid detecting module and the humidity detecting module are chosen. Refer to FIG. 4 which shows an assembling method of the detecting device according to an embodiment.

Because the commercial power is not available in the paddy field, the power module 130 with a solar cell in built can be used, for powering the detecting module 110 and the server module 120. For detecting the water quality and the solid in the paddy field, the power module 130 may be arranged at the top-most position of the field detecting device. Then, the server module 120 is assembled below the power module 130. Finally, the signal transmitting module 140 and the water quality/solid detecting module 185 are assembled below the server module 120, for receiving the information related to the water quality and the solid.

Accordingly, the present disclosure provides a detecting device 100, wherein the detecting modules 110 can be assembled in different orders according to the various planting environments, so as to obtaining the environment detecting signals effectively in the different planting environments.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A field detecting device, comprising:
at least one detecting module for receiving environment detecting signals, the at least one detecting module has a first casing in the shape of column, an upper surface of the first casing being provided with a first fixing structure and first connecting pins, and a lower surface of the first casing being provided with a second fixing structure and second connecting pins, and the at least one detecting module being electrically connected between the first connecting pins and the second connecting pins;
a server module for storing an environment detecting program, the server module being provided in a second casing in the shape of column, an upper surface of the second casing being provided with a first fixing structure and first connecting pins, and a lower surface of the second casing being provided with a second fixing structure and second connecting pins, and the server module being electrically connected between the first connecting pins and the second connecting pins; and
a power module provided in a third casing in the shape of column, an upper surface of the third casing being provided with a first fixing structure and first connecting pins, and a lower surface of the third casing being provided with a second fixing structure and second connecting pins, and the power module being electrically connected between the first connecting pins and the second connecting pins;
wherein the first fixing structure of one of the at least one detecting modules, the server module and the power module is assembled with the second fixing structure of another module of the at least one detecting modules, the server module and the power module, the server module drives the at least one detecting module according to the environment detecting program, so as to receive the environment detecting signals,
wherein the power module is assembled with the at least one detecting module or with the server module, for powering the at least one detecting module and the server module.

2. The field detecting device according to claim 1, wherein the environment detecting signals include: video signals, acoustic signals, olfactory signals, taste signals, pressure signals, temperature signals, humidity signals, water quality detecting signals or solid detecting signals.

3. The field detecting device according to claim 1, further comprising a signal transmitting module provided in a fourth casing in the shape of column, an upper surface of the fourth casing being provided with a first fixing structure and first connecting pins, and a lower surface of the fourth casing being provided with a second fixing structure and second connecting pins, and the signal transmitting module being electrically connected between the first connecting pins and the second connecting pins, and the signal transmitting module being adapted to send the environment detecting signals.

4. The field detecting device according to claim 3, wherein the transmission type of the signal transmitting module is one of Ethernet, IEEE 802.11 wireless network, 3G mobile communication, WiMax, Ultra-wide band and Universal Serial Bus (USB).

5. The field detecting device according to claim 3, wherein the first casing, the second casing, the third casing and the fourth casing are polyhedral columns.

6. The field detecting device according to claim 1, wherein the first fixing structures and the second fixing structures are crew fixing structures, spiral fixing structures, joint structures or magnetic fixing structures.

7. The field detecting device according to claim 1, wherein the power module is a solar cell, a hydrogen-oxygen cell, a lithium cell, a zinc-manganese cell, a carbon-zinc cell or an external power.

8. The field detecting device according to claim 1, wherein the first fixing structure of the second casing is assembled with the second fixing structure of the first casing or with the second fixing structure of the third casing, and the first connecting pins of the second casing is connected with the second connecting pins of the first casing or with the second connecting pin of the third casing.

9. The field detecting device according to claim 1, wherein the first fixing structure of the third casing is assembled with the second fixing structure of the first casing or with the second fixing structure of the second casing, and the first connecting pin of the third casing is connected with the second connecting pins of the first casing or with the second connecting pin of the second casing.
